(19) United States
(12) Patent Application Publication
(10) Pub. No.: US 2009/0079720 A1
(43) Pub. Date: Mar. 26, 2009

(54) METHOD OF DRIVING PLASMA DISPLAY PANEL AND IMAGE DISPLAY

(76) Inventors: Mitsuhiro Murata, Kyoto (JP); Toshikazu Wakabayashi, Osaka (JP); Kyohei Yoshino, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/297,309

(22) PCT Filed: May 1, 2007
(86) PCT No.: PCT/JP2007/059309

§ 371 Date: Oct. 21, 2008

(30) Foreign Application Priority Data
May 1, 2006 (JP) 2006-127284

(51) Int. Cl. G09G 5/00

(52) U.S. Cl. 345/205

(57) ABSTRACT

An object of the present invention is to display an image with a good image quality when driving a PDP, by stabilizing an initialization operation to suppress a false discharge when a writing operation is performed.

Therefore, in a method of driving a PDP of the present invention, one TV field is composed of a plurality of subfields each including an initialization period (31), a writing period (32), a sustain period (33), and an elimination period (34).

When an immediately preceding subfield does not include the sustain period (33), a priming pulse (Vpr) is applied to address electrodes (D1 to Dm) prior to a ramp waveform part (S1) of an initialization pulse applied to scan electrodes (SCN1 to SCNn), after the writing operation ends. When the immediately preceding subfield includes the sustain period (33), the priming pulse (Vpr) is applied to the address electrodes (D1 to Dm) prior to the ramp waveform part (S1), after the sustain period ends.

### TECHNICAL FIELD

The present invention relates to a driving method of a plasma display panel used for displaying an image of a computer, a television, or the like, and an image display device.

### BACKGROUND ART

In recent years, a plasma display panel (hereinafter, referred to as “PDP”) is used for an image display device such as a computer, a television, or the like. An AC surface discharge type PDP that is currently mainstream has the following structure. The AC surface discharge type PDP includes a front panel and a back panel that are sealed with each other. In the front panel, scan electrodes and sustain electrodes are arranged on a front glass substrate in a stripe state. Also, a dielectric layer and a protection layer are laminated on the front glass substrate so as to cover the scan electrodes and the sustain electrodes. On the other hand, in the back panel, address electrodes are arranged on a back glass substrate in a stripe state. Also, a protection layer is formed on the back glass substrate so as to cover the address electrodes, and barrier ribs are formed on the protection layer.

Phosphor layers for red, green, and blue are generally applied to an inner wall of each of the barrier ribs for color display. Also, a discharge gas is enclosed in each discharge space separated by the barrier ribs.

When a television image is displayed in an NTSC system, images of 60 frames are displayed for one second. However, a PDP can originally perform gradation expression of two gradations that are lighting and non-lighting. Therefore, the following method is used. Firstly, one frame is divided into a plurality of subfields (hereinafter, referred to as “S.F.”). Then, an intermediate color is expressed according to combinations of the subfields. For example, a ratio of the number of sustain pulses applied in a discharge sustain period of each S.F. is weighted in a binary mode, so as to obtain 1, 2, 4, 8, 16, 32, 64, and 128. As a result, each of red, green, and blue is expressed in 256 gradations.

Each S.F. is further divided into an initialization period, a writing period, a sustain period, and an elimination period. In the initialization period, a wall charge necessary for generating a writing discharge is accumulated by a weak discharge. In the writing period, a cell to be lighted by the writing discharge is selected. In the sustain period, a sustain operation is performed only on the cell lighted by the writing discharge to sustain a light emission of the cell. In the elimination period, an elimination operation is performed only on the cell on which the sustain operation has been performed in the immediately preceding sustain period, in order to selectively generate an elimination discharge and eliminate the wall charge. As a result of a sequence including initialization, writing, sustainment, and elimination, an image is displayed.

In such a PDP, a request for high definition has been increased in order to realize a higher image quality, in addition to realization of a large size, a flat screen, and light weight. Also, development in response to the request has been advanced.

For example, patent documents 1 and 2 disclose the following technique. By applying an initialization pulse having a ramp waveform part in which an electric potential changes in a gentle slope, a slight discharge is generated in a discharge cell to accumulate a desired wall charge. This enables the next writing operation to be stably performed.

Also, the patent documents 1 and 2 disclose the following technique. In the technique, (i) initialization of all discharge cells for generating an initialization discharge in each of all discharge cells is combined with (ii) selective initialization for selectively generating an initialization discharge in a cell on which a sustain discharge has been performed in the immediately preceding S.F. For example, the initialization of all cells is performed in a first S.F. in one TV field, and the selective initialization is performed in each S.F. after the first S.F. This can realize a good contrast.

Moreover, because a cell opening ratio decreases along with high definition of a PDP, a luminance decreases and an image tends to be totally dark. In view of the above problem, the following technique has also been brought to the attention. In the technique, a maximum luminance is secured to display an image with a high image quality by setting a high partial pressure ratio of xenon and krypton for emitting visible light or a high total pressure of a discharge gas. For example, the following setting has been examined. The total pressure is in a range of 180 Torr to 750 Torr, and the partial pressure of xenon is each of 10%, 15%, 20%, 30%, 50%, 80%, 90%, 95%, 98%, and 100%.
Patent Document 1: Japanese Published Patent Application No. 2000-214823
Patent Document 2: Japanese Published Patent Application No. 2005-321680
Non-patent Document 1: Technical Report of the Institute of Electrical Engineers of Japan No. 688, on page 19, a table 2.8
Non-patent Document 2: IDW' 04 PDP7-2

### DISCLOSURE OF THE INVENTION

### The Problems to be Solved by the Invention

As mentioned above, originally, a weak discharge is generated to accumulate a desired wall charge by applying an initialization pulse having a ramp waveform part. However, a strong discharge by which ionization multiplication temporally drastically proceeds may be generated in an initialization period. If the strong discharge is generated, an excessive wall charge that cancels an electric field in a discharge cell is accumulated. As a result, a wall potential higher than the desired wall potential is formed when the initialization period ends. Because of this, a light emission of a discharge cell on which a writing operation has not been performed is sustained in a sustain period. As a result, an image cannot be normally displayed, and flicker and roughness occur in the image (refer to the patent document 1). Also, if the strong discharge is generated, a black luminance increases and a contrast ratio remarkably decreases. When an image including many low gradation expressions is displayed, an image quality is remarkably deteriorated.

In view of the above problem, the following technique has been known. The technique is for decreasing generation of the strong discharge in the initialization period by reducing an electric potential difference between electrodes in which the strong discharge is likely to be generated (refer to the patent document 2).

In an example shown in FIG. 6, for example, in a time period in the vicinity of a peak of a voltage of an initialization pulse applied to scan electrodes SCN1 to SCNn, a voltage of the same polarity as a polarity of the initialization pulse is applied to address electrodes D1 to Dm. As a result, an electric potential difference between electrodes in which the strong discharge is likely to be generated (between the scan electrodes and the address electrodes) can be smaller enough than an electric potential difference by which a discharge is generated. This can reduce the generation of the strong discharge.

However, if an electric potential difference between electrodes is reduced when an initialization pulse is applied, an enough voltage in a discharge cell for normally performing a writing operation cannot be secured, and an image cannot be normally displayed.

Then, the following describes a problem caused by high definition of a PDP. Along with high definition of a PDP, a volume of one discharge cell becomes smaller, and a ratio of a surface area to the volume of the discharge cell increases. This increases an energy loss by heat generation caused by reabsorption and elastic collision of charged particles in a wall surface. As a result, the number of the charged particles in the discharge cell decreases before the initialization period. Also, if the number of the charged particles is small, it is required to set a drive voltage high in each period. However, when the drive voltage is set high, an electric field intensity in a discharge space around an electrode and an electrode surface becomes large. This increases a probability that ionization multiplication temporally drastically proceeds. As a result, a strong discharge is likely to be generated in the initialization period.

Also, if a partial pressure ratio of each of xenon and krypton becomes high, a strong discharge is likely to be generated.

This is because of the following reason. An element having a large atomic number such as xenon or krypton has a small first ionization energy. Therefore, xenon or krypton has a very small secondary electron emission coefficient compared with helium, neon, and argon each of which has a large first ionization energy (refer to the non-patent document 1). Therefore, an absolute number of electrons supplied from a protection film surface to a discharge space becomes small, and a threshold voltage necessary for starting a discharge becomes high. As a result, a strong electric field is generated in a discharge cell, and a strong discharge is likely to be generated.

As mentioned above, in a high-definition PDP or a PDP in which a partial pressure ratio of each of xenon and krypton is high, the generation of the strong discharge is prominent. Therefore, it is difficult to suppress the generation of the strong discharge in the initialization period even if an electric potential difference between electrodes is reduced as in the conventional technique.

In view of the above problem, an object of the present invention is to suppress the generation of the strong discharge in the initialization period when driving the PDP, in order to prevent flicker and roughness in an image and realize image display with high definition and a high image quality.

### Means of Solving the Problems

The above-mentioned object can be achieved by a method of driving a plasma display panel to display an image, the plasma display panel including a first substrate having one or more first electrodes, a second substrate having one or more second electrodes, the first and second substrates being arranged in opposition to each other so that the first electrodes cross over the second electrodes, and a discharge gas enclosed between the first electrodes and the second electrodes, and in the method, one TV field being composed of a plurality of subfields each including, out of an initialization period, a writing period, and a sustain period, one of combinations (a) the initialization period and the writing period, (b) the initialization period and the sustain period, and (c) the initialization period; the writing period, and the sustain period, wherein in at least one of the plurality of subfields, an initialization pulse is applied to the first electrodes in the initialization period, the initialization pulse having a sloping part that changes at a voltage change rate in a range of 0.1 V/μsec to 10 V/μsec, and a priming pulse of a same polarity as a polarity of the initialization pulse is applied to the second electrodes prior to the sloping part of the initialization pulse (i) after the writing period when a subfield immediately preceding to the initialization period includes the combination (a), and (ii) after the sustain period when the immediately preceding subfield includes the combination (b) or the combination (c).

It is preferable that this priming pulse is applied to the second electrodes immediately prior to the sloping part of the initialization pulse.

Here, the case where the immediately preceding subfield includes (a) the initialization period and the writing period means a case where the immediately preceding subfield includes the initialization period and the writing period, and does not include the sustain period. Also, the case where the immediately preceding subfield includes (b) the initialization period and the sustain period means a case where the immediately preceding subfield includes the initialization period and the sustain period, and does not include the writing period. Therefore, when the subfield immediately preceding to the initialization period does not include the sustain period, the priming pulse is applied to the second electrodes after the writing period of the immediately preceding subfield. When the subfield immediately preceding to the initialization period includes the sustain period, the priming pulse is applied to the second electrodes after the sustain period.

Note that it goes without saying that a subfield including (a) the initialization period and the writing period, a subfield including (b) the initialization period and the sustain period, and a subfield including (c) the initialization period, the writing period, and the sustain period may be mixed in the plurality of subfields composing the one TV field. Also, “the initialization period of the subfield” may be any of the all cells initialization period and the selective initialization period.

Also, “a sloping part that changes at a voltage change rate in a range of 0.1 V/μsec to 10 V/μsec” is not limited to a ramp waveform and a dull wave in which a voltage gently changes. The sloping part may be a stepwise waveform in which a voltage stepwise changes, if an average voltage change rate is in a range of 0.1 V/μsec to 10 V/μsec.

It is preferable that a voltage of the priming pulse applied to the second electrodes is larger than a threshold voltage at which a discharge is generated in a discharge cell by the priming pulse, the discharge cell being formed in each crossing part of the first electrodes and the second electrodes. Also, the voltage of the priming pulse may be set to be 0.1 Vf or larger and smaller than Vf, where Vf represents a threshold voltage at which a discharge is generated in a discharge cell by the priming pulse, the discharge cell being formed in each crossing part of the first electrodes and the second electrodes.

It is also preferable that the voltage of the priming pulse is in a range of Vmin to Vmax, where Vmax represents a maximum voltage of the initialization pulse applied to the first electrodes and Vmin represents a minimum voltage of the initialization pulse.

If a PDP has a three-electrode structure including a pair of discharge electrodes and an address electrode, it is preferable that the initialization pulse is applied to one of the pair of discharge electrodes, and the priming pulse of the same polarity as a polarity of the initialization pulse is applied to the address electrode.

Here, when the priming pulse is applied to the address electrodes, it is preferable that a voltage generated between the address electrodes and the other discharge electrode is larger than a threshold voltage at which a discharge is generated in the discharge cell. It is also preferable that a voltage generated between the address electrodes and the other discharge electrode is 0.1 Vf or larger and smaller than Vf, where Vf represents a threshold voltage at which a discharge is generated in the discharge cell.

Also, when the same-polarity priming pulse is applied to the address electrodes, a priming pulse of an opposite polarity of the polarity of the initialization pulse is applied to the other discharge electrode.

The opposite-polarity priming pulse may have a ramp waveform part.

The above-mentioned object can be achieved by a method of driving a plasma display panel to display an image, in which in at least one of the plurality of subfields, an initialization pulse is applied to the first electrodes in the initialization period, the initialization pulse having a sloping part that changes at a voltage change rate in a range of 0.1 V/μsec to 10 V/μsec, and the second electrodes are put into a floating state prior to the sloping part of the initialization pulse (i) after the writing period when a subfield immediately preceding to the initialization period includes (a) the initialization period and the writing period, and (ii) after the sustain period when the immediately preceding subfield includes (b) the initialization period and the sustain period or (c) the initialization period, the writing period, and the sustain period.

Here, it is preferable that when a voltage of a same polarity as a polarity of the initialization pulse is applied to the first electrodes, the second electrodes are put into the floating state.

### EFFECTS OF THE INVENTION

With the above-stated construction, a priming pulse of a same polarity as a polarity of the initialization pulse is applied to the second electrodes prior to the sloping part of the initialization pulse (i) after the writing period when a subfield immediately preceding to the initialization period includes (a) the initialization period and the writing period, and (ii) after the sustain period when the immediately preceding subfield includes (b) the initialization period and the sustain period or (c) the initialization period, the writing period, and the sustain period. In other words, when the subfield immediately preceding to the initialization period does not include the sustain period, the priming pulse of the same polarity as a polarity of the initialization pulse is applied to the second electrodes after the writing period of the immediately preceding subfield. When the subfield immediately preceding to the initialization period includes the sustain period, the priming pulse of the same polarity as a polarity of the initialization pulse is applied to the second electrodes after the sustain period. Therefore, a priming discharge is generated because of the application of the priming pulse, and a density of charged particles in a discharge space increases (hereinafter, such an operation is referred to as “priming operation”). Thus, when the sloping part of the initialization pulse is applied, a slight discharge is likely to be generated and the generation of a strong discharge can be suppressed.

If the generation of the strong discharge is suppressed, flicker and roughness in an image is remarkably improved to display the image with a high definition, and a contrast ratio increases.

In order to obtain the above effect, it is preferable that the priming pulse is applied to the second electrodes immediately prior to the sloping part of the initialization pulse.

As in the conventional technique, if the pulse of the same polarity as a polarity of the initialization pulse is applied to the second electrodes when the sloping part of the initialization pulse is applied, an electric potential difference between the first electrodes and the second electrodes becomes small in the case of the all cells initialization operation, and becomes large in the case of the selective initialization operation. Therefore, this causes a problem that a wall charge cannot be normally formed by the initialization operation in a state of neither too much nor too little in any case, and the following writing operation cannot be normally performed. On the other hand, in the present invention, when the sloping part of the initialization pulse is applied to the first electrodes, the application of the priming pulse has been completed. Therefore, an electric potential difference between the first electrodes and the second electrodes is kept at an electric potential difference desired for the initialization operation. As a result, the application of the priming pulse does not prevent the wall charge from being formed by the initialization operation.

In the present invention, the priming pulse is applied to the second electrodes prior to the sloping part of the initialization pulse. Therefore, when the sloping part of the initialization pulse is applied to the first electrodes, the application of the priming pulse has been completed.

Thus, an electric potential difference between the first electrodes and the second electrodes does not become small by applying the pulse to the second electrodes when the sloping part of the initialization pulse is applied as in the conventional technique. As a result, the original formation of the wall charge is not prevented.

Here, if a voltage of the priming pulse is set to be larger than a threshold voltage at which a discharge is generated in a discharge cell by the priming pulse, a priming operation can be certainly performed. On the other hand, if a voltage of the priming pulse is set to be 0.1 Vf or larger and smaller than Vf, where Vf represents a threshold voltage at which a discharge is generated in a discharge cell by the priming pulse, a light emission caused by the priming operation can be suppressed. Therefore, a contrast ratio can be improved.

Especially if a voltage of the priming pulse is set to be 0.5 vf or larger and smaller than Vf, both an effect of suppressing a light emission caused by the priming operation and an effect of suppressing the strong discharge caused by the priming operation can be expected.

If a PDP has a three-electrode structure including a pair of discharge electrodes and an address electrode, an initialization pulse is applied to one of the pair of discharge electrodes, and a priming pulse of the same polarity as a polarity of the initialization pulse is applied to the address electrode. As a result, a priming discharge can be generated between the other discharge electrode and the address electrode. In other words, an electrode to which the initialization pulse is applied is not used in the priming discharge, and the priming discharge can be performed between other electrodes. This can prevent the priming discharge itself from becoming the strong discharge.

Here, when the priming pulse of the same polarity as a polarity of the initialization pulse is applied to the address electrode, a priming pulse of the opposite polarity to a polarity of the initialization pulse is applied to the other discharge electrode. As a result, the priming discharge can be certainly generated between the other discharge electrode and the address electrode, even if a voltage of the priming pulse applied to the address electrode is small.

If a ramp waveform part that gently changes is provided for the priming pulse of the opposite polarity to a polarity of the initialization pulse, a light emission caused by the priming discharge and a false discharge caused by a rapid voltage change such as a rectangular wave can be suppressed.

When there are a plurality of first electrodes and voltages of different polarities are applied to the plurality of first electrodes, the second electrodes are put into a floating state prior to the sloping part of the initialization pulse, (i) after the writing period when a subfield immediately preceding to the initialization period includes (a) the initialization period and the writing period, and (ii) after the sustain period when the immediately preceding subfield includes (b) the initialization period and the sustain period or (c) the initialization period, the writing period, and the sustain period. As a result, electric potentials of the second electrodes partially change in the same polarity as a polarity of the voltage applied to one of the first electrodes. Therefore, the priming discharge can be generated between the part of the second electrodes whose voltage partially changes and the other first electrode to which the voltage of the opposite polarity of the part of the second electrodes is applied.

When the voltage of the same polarity as a polarity of the initialization pulse is applied to the first electrodes, if the second electrodes are put into a floating state, electric potentials of the second electrodes change in a direction of the same polarity of the voltage applied to the first electrodes. Therefore, the priming discharge can be generated because of the electric potential change of the second electrodes.

If the priming discharge is generated, a density of charged particles in a discharge space becomes high and a slight discharge is likely to be generated, when the sloping part of the initialization pulse is applied. As a result, the generation of the strong discharge can be suppressed.

If the second electrodes are put into the floating state, it is not required to apply the priming pulse to the second electrodes. Therefore, the priming discharge can be generated while suppressing an increase of power consumption.

The present invention is effective as a technique of suppressing the strong discharge in the initialization period. The effect of the present invention can be expected especially in a high-definition PDP and a high-luminance and high-efficient PDP in which a total pressure ratio of a discharge gas and a partial pressure ratio of xenon are high.

### BRIEF DESCRIPTION OF THE DRAWINGS

FIG. 1 is a perspective view showing main parts of a PDP of embodiments of the present invention;

FIG. 2 is an electrode connection diagram of the PDP of the embodiments of the present invention;

FIG. 3 is a block diagram showing a device structure of the PDP of the embodiments of the present invention.

FIG. 4 is a configuration diagram of subfields composing one TV field in a driving method of the PDP;

FIG. 5 is a timing chart of a drive voltage applied to each electrode in a driving method of a first embodiment;

FIG. 6 is a timing chart of a drive voltage applied to each electrode in a driving method of a conventional technique;

FIG. 7 is a timing chart of a drive voltage applied to each electrode in the driving method of the first embodiment and an APD waveform;

FIG. 8 is a timing chart of a drive voltage applied to each electrode in a driving method of a second embodiment;

FIG. 9 is a timing chart of a drive voltage applied to each electrode in a driving method of a third embodiment and an APD waveform;

FIG. 10 is a timing chart of a drive voltage applied to each electrode in a driving method of a fourth embodiment and an APD waveform;

FIG. 11 is a timing chart of a drive voltage applied to each electrode in a driving method of a fifth embodiment;

FIG. 12 is a timing chart of a drive voltage applied to each electrode in a driving method of a sixth embodiment;

FIG. 13 shows a drive wave form applied to a scan electrode in an all cells initialization period, and an APD waveform when a weak discharge is normally generated;

FIG. 14 shows a drive waveform applied to a scan electrode in an all cells initialization period, and an APD waveform when a strong discharge is generated;

FIG. 15 shows an example of an address electrode drive circuit for outputting a drive waveform of the first embodiment;

FIG. 16 shows an example of an address electrode drive circuit for outputting a drive waveform of the first embodiment;

FIG. 17 shows an example of a sustain electrode drive circuit for outputting a drive waveform of the third embodiment;

FIG. 18 shows an example of a sustain electrode drive circuit for outputting a drive waveform of the third embodiment;

FIG. 19 shows an example of a sustain electrode drive circuit for outputting a drive waveform of the third embodiment;

FIG. 20 shows a limit slope of a ramp voltage on an initialization operation for each statistical variation time Ts of a discharge starting time, in driving methods of a first conventional example and the first embodiment;

FIG. 21 shows examples of a voltage waveform used in an initialization period;

FIG. 22 shows an example of a circuit for generating a priming pulse; and

FIG. 23 is a timing chart showing an operation of the above circuit.

### DESCRIPTION OF REFERENCE NUMERALS

1: PDP
PA1: front panel
PA2: back panel
SUS1 to SUSn: sustain electrode
SCN1 to SCNn: scan electrode
D1 to Dm: address electrode
11: front glass substrate
12: back glass substrate
13: protection layer
15: barrier rib
16: phosphor layer
17: dielectric layer
18: protection layer
20: discharge space
21: scan electrode drive circuit
22: sustain electrode drive circuit
23: address electrode drive circuit
24: timing generation unit
31: all cells initialization period
32: writing period
33: sustain period
34: elimination period
35: priming period
36: selective initialization period

### BEST MODE FOR CARRYING OUT THE INVENTION

A PDP device for carrying out the present invention is composed of a PDP 1 having an area for displaying an image and a drive unit for driving the PDP 1.

### (Panel Structure)

The following describes a cell structure and an electrode arrangement of the PDP 1. Note that the present invention can be applied not only to the PDP 1, but also to a general AC surface discharge type PDP.

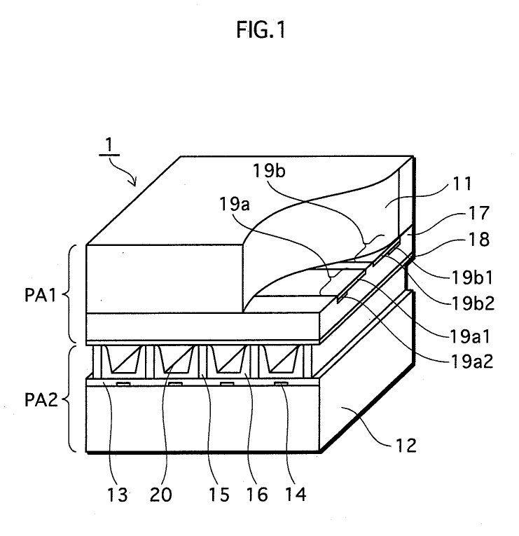

As shown in FIG. 1, the PDP 1 is composed of a front panel PA1 and a back panel PA2 sealing with each other. In the front panel PA1, a plurality of pairs of discharge electrodes composed of a scan electrode 19a and a sustain electrode 19b are arranged on a front glass substrate 11 in a stripe state. Also, a dielectric layer 17 and a protection layer 18 are laminated on the front glass substrate 11 so as to cover the scan electrode 19a and the sustain electrode 19b. The scan electrode 19a is composed of a transparent electrode 19a1 and a metal electrode 19a2, and the sustain electrode 19b is composed of a transparent electrode 19b1 and a metal electrode 19b2.

In the front panel PA2, a plurality of address electrodes 14 are arranged on a back glass substrate 12 in a stripe state. Also, a protection layer 13 is formed on the back glass substrate 12 so as to cover the address electrodes 14, and barrier ribs 15 are formed on the protection layer 13. The plurality of pairs of discharge electrodes cross over the address electrodes 14, and a discharge cell is formed in each crossing part. The barrier ribs 15 are formed along the address electrodes 14 in a stripe state, or formed so as to surround a discharge space 20 of each discharge cell.

A phosphor layer 16 is applied to an inner surface of each of the barrier ribs 15. Generally, phosphor layers in three colors of red, green, and blue are arranged in the stated order for color display.

A discharge gas is enclosed in the discharge space 20 separated by each of the barrier ribs 15. This discharge gas is a mixed gas selected from the group consisting of helium, neon, argon, krypton, and xenon, and is generally enclosed at a pressure of about 67 kPa.

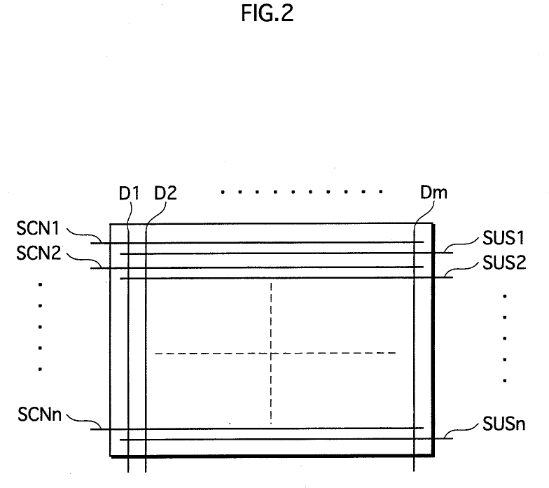

FIG. 2 is an overall electrode connection diagram of the PDP 1.

In the PDP 1, n scan electrodes SCN1 to SCNn and n sustain electrodes SUS1 to SUSn are alternately arranged in rows. Also, m address electrodes D1 to Dm are arranged in columns.

### (Driving Method of the PDP 1)

The following describes a gradation expression method of driving the PDP 1.

Originally, only two gradations that are lighting and non-lighting can be expressed in a PDP. Therefore, a subfield method is generally used for driving a PDP. When a television picture is displayed, for example, a picture in an NTSC method is composed of 60 TV fields for one second. Also, 1 TV field is divided into a plurality of subfields (hereinafter, referred to as “S.F.”) to perform time division of a lighting time of each of red, green, and blue. As a result, an intermediate color is expressed using combinations of the plurality of subfields. For example, 1 frame is divided into 8 S.F., and a ratio of the number of sustain pulses applied to each S.F. is weighted in a binary mode, so as to obtain 1, 2, 4, 8, 16, 32, 64, and 128. As a result, 256 gradations are expressed using combinations of lighted S.F.

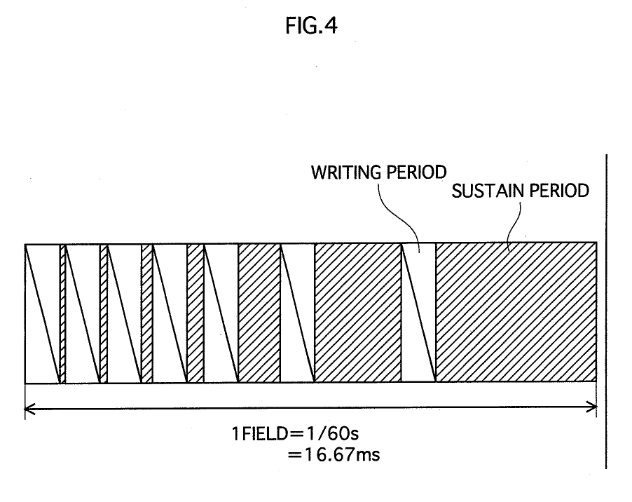

FIG. 4 is a diagram showing the gradation expression method of driving the PDP 1.

In order to control a discharge operation of a discharge cell, each S.F. is divided into an initialization period, a writing period, a sustain period, and an elimination period, and displays an image by a sequence.

The following specifically describes each of the above periods.

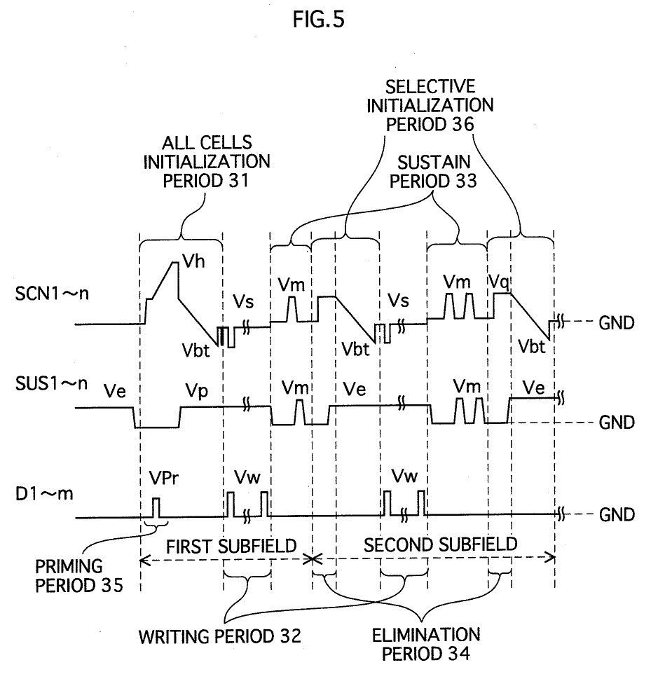

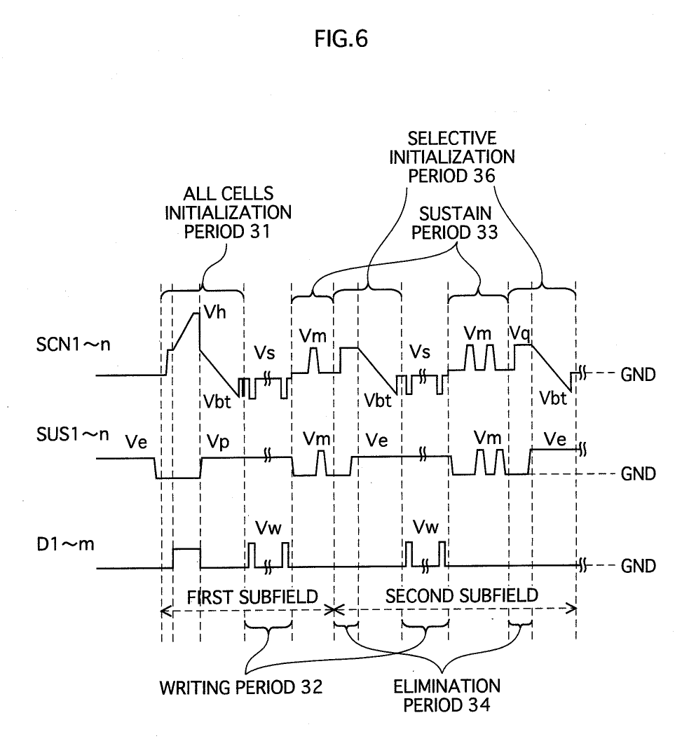

FIG. 5 is a chart showing a drive voltage waveform applied to each electrode by each drive circuit, and shows a first S.F. and a second S.F. in 1 TV field.

### <Initialization Period>

In an initialization period, an initialization pulse is collectively applied to all of the scan electrodes SCN1 to SCNn to generate a weak discharge, and a wall charge suitable for an operation in a writing period following the initialization period is accumulated (a wall potential suitable for controlling a writing discharge is formed).

In this embodiment, the first S.F. in 1 TV field includes an all cells initialization period 31 in which an all cells initialization pulse is applied to generate an initialization discharge in each of discharge cells. On the other hand, each S.F. following the first S.F. includes a selective initialization period 36 in which a selective initialization pulse is applied to generate an initialization discharge only in a discharge cell in which a sustain discharge has been performed in a preceding S.F.

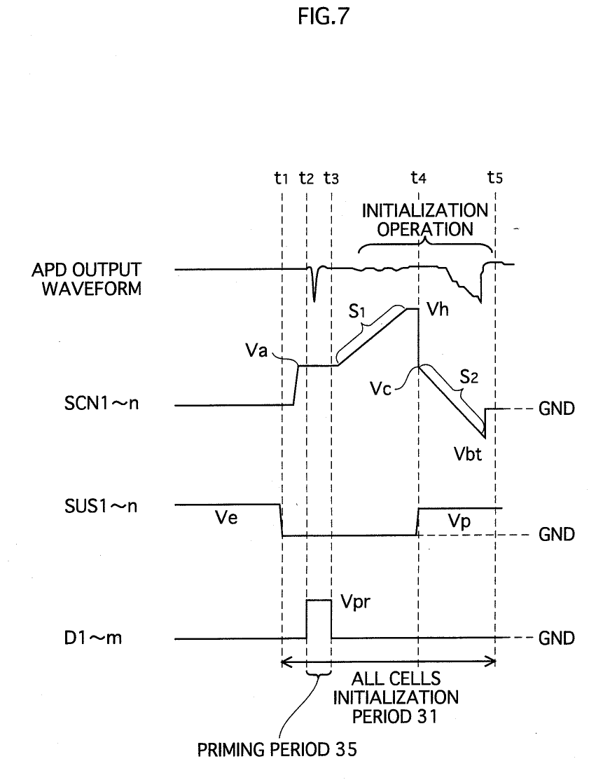

As shown in FIG. 7, the all cells initialization pulse applied in the first S.F. includes the following two parts in an anterior half thereof. In one of the parts, an electric potential changes from a ground potential 0(V) to a positive electric potential Va(V) (a period from t1 to t2 in FIG. 7). The other part is a ramp waveform part S1 (a period from t3 to t4 in FIG. 7) in which the electric potential gently changes from Va(V) to an electric potential Vh(V) in a positive slope (a slope in a range of 0.1 V/μsec to 10 V/μsec).

In this case, the sustain electrodes SUS1 to SUSn and the address electrodes D1 to Dm are basically kept at the ground potential 0(V). Although it will be specifically described in the following embodiments, it is preferable to apply a priming pulse to the address electrodes D1 to Dm prior to the ramp waveform part S1. In the embodiment shown in FIG. 7, the priming pulse is applied to the address electrodes D1 to Dm in a period from t2 to t3.

A posterior half of the all cells initialization pulse includes a ramp waveform part S2 (a period from t4 to t5 in FIG. 7) in which the electric potential gently changes from an electric potential Vc (V) to an electric potential Vbt (V) in a negative slope (a slope in a range of 0.1 V/μsec to 10 V/μsec).

A value of the voltage Vh is equal to or larger than a minimum voltage (threshold voltage) Vf at which a discharge starts between the scan electrodes SCN1 to SCNn and any of the sustain electrodes SUS1 to SUSn and the address electrodes D1 to Dm, and a value of the voltage Vbt is equal to or smaller than the threshold voltage Vf.

In the ramp waveform part S1, an electric potential difference in the discharge space 20 is larger than an electric potential difference when a discharge starts, and a slight gas discharge (a weak discharge by which ionization multiplication temporally gently proceeds) is generated in the discharge space 20. As a result, an electric charge generated by the slight gas discharge is accumulated as a wall charge around the address electrodes, the scan electrodes, and the sustain electrodes in a wall surface surrounding the discharge space 20. When this wall charge is accumulated, in order to weaken an electric field of each of the discharge space 20 and surfaces of the electrodes, a negative electric charge is accumulated on a surface of the protection layer 18 around the scan electrodes SCN1 to SCNn, and a positive electric charge is accumulated on a surface of the protection layer 18 around the sustain electrodes SUS1 to SUSn and a surface of the phosphor layer 16 around the address electrodes D1 to Dm.

In the ramp waveform part S2, the applied voltage to the scan electrodes changes from a positive voltage to a negative voltage, and a weak discharge is generated. This weak discharge weakens the negative electric charge accumulated on the surface of the protection layer 18 around the scan electrodes SCN1 to SCNn and the positive electric charge accumulated on the surface of the protection layer 18 around the sustain electrodes SUS1 to SUSn.

As mentioned above, all of the discharge cells are initialized by the two slight discharges, and the wall potential suitable for the writing operation is formed between the scan electrodes, the address electrodes, and the sustain electrodes.

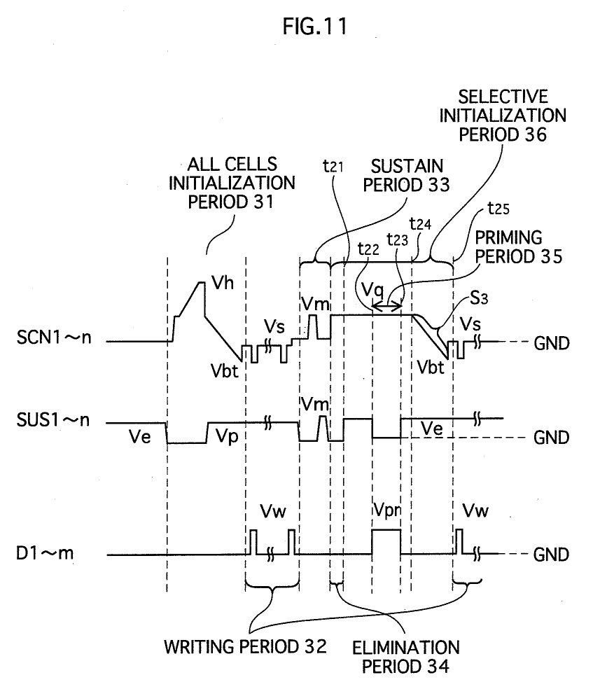

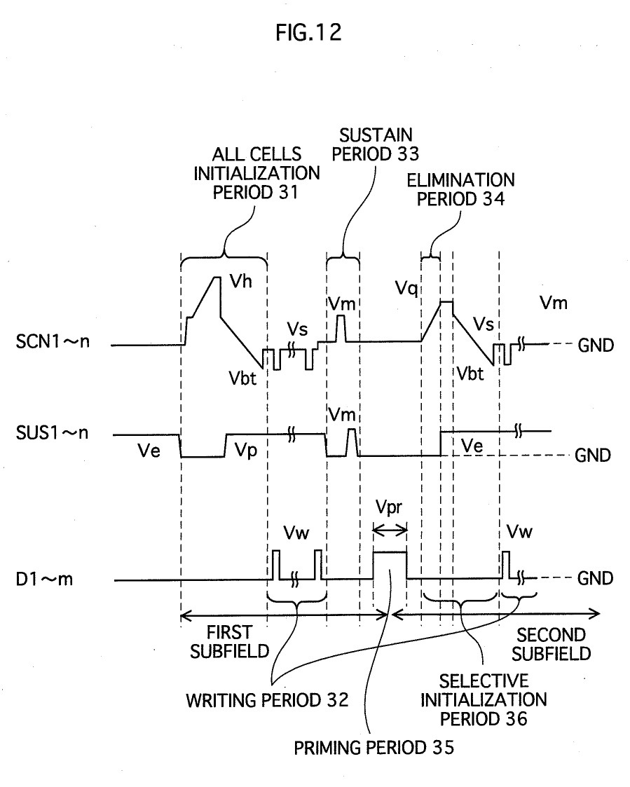

As shown in FIGS. 11 and 12, a selective initialization pulse applied to the scan electrodes SCN1 to SCNn in each S.F. following the first S.F. includes a ramp waveform part S3 (a period from t24 to t25 in FIG. 11) in which the voltage gently changes from a voltage Vq(V) to a voltage Vbt(V) in a negative slope (a slope in a range of 0.1 V/μsec to 10 V/μsec).

In this case, the sustain electrodes SUS1 to SUSn are kept at a voltage Vh(V) and the address electrodes D1 to Dm are basically kept at a ground potential 0(V).

Although it will be described later in fifth and sixth embodiments, it is preferable to apply a priming pulse to the address electrodes D1 to Dm prior to the ramp waveform part S3. In the embodiment shown in FIG. 11, the priming pulse is applied to the address electrodes D1 to Dm in a period from t22 to t23.

Because the selective initialization pulse is applied, in a discharge cell in which a sustain discharge has been performed in a sustain period of the preceding subfield, a slight initialization discharge is selectively generated, a wall voltage on each of the scan electrodes SCN1 to SCNn and the sustain electrodes SUS1 to SUSn is weakened, and a wall voltage on the address electrodes D1 to Dm is adjusted to a value suitable for the writing operation. On the other hand, in a discharge cell in which a writing discharge and a sustain discharge have not been performed in the preceding subfield, a discharge is not generated and a state of a wall voltage when an initialization period of the preceding subfield is kept.

Note that the voltage waveform of the initialization pulse is not limited to the above voltage waveform, and may be a voltage waveform in which an electric potential difference between the scan electrodes and the address electrodes gently increases or decreases (a voltage change rate is in a range of 0.1 V/μsec to 10 V/μsec), and a slight discharge is continuously generated within the period in which the voltage gently changes. By applying a priming pulse to the address electrodes D1 to Dm before the period in which the voltage gently changes, the generation of the strong discharge can be suppressed when the initialization operation is performed.

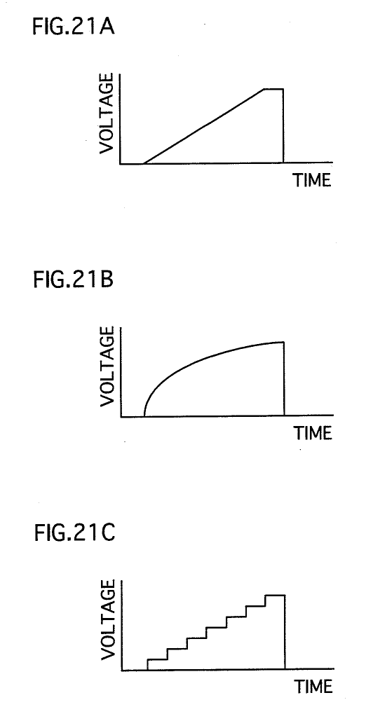

As shown in FIG. 21, the initialization pulse may be in a waveform having a sloping part that changes at a voltage change rate in a range of 0.1 V/μsec to 10 V/μsec, such as a dull wave, a stepwise waveform, or a waveform combining a ramp waveform, the dull wave, and the stepwise waveform.

### <Writing Period 32>

In the writing period 32, a discharge cell to be lighted by the writing discharge is selected. In other words, the writing discharge is generated by applying a scan pulse having a lower voltage than a voltage of the address electrodes D1 to Dm and the sustain electrodes SUS1 to SUSn to the scan electrodes SCN1 to SCNn, and further applying an address pulse only to the address electrodes of the discharge cell to be lighted at a voltage Vw at which a same sign voltage difference as the wall potential is generated between the scan electrodes and the address electrodes.

Because of this, in the discharge cell to be lighted, a negative electric charge is accumulated as a wall charge on a surface of the phosphor layer 16 and a surface of the protection layer 13 around the sustain electrodes, and a positive electric charge is accumulated as a wall charge on a surface of the protection layer 13 around the scan electrodes. When the writing period ends and all of the electrodes are grounded, a wall potential necessary for generating a sustain discharge between the scan electrodes and the sustain electrodes is formed by the wall charge.

### <Sustain Period 33>

In a sustain period 33, a sustain pulse is applied to the scan electrodes SCN1 to SCNn and the sustain electrodes SUS1 to SUSn to perform a sustain operation of sustaining a light emission of only a discharge cell in which the writing discharge has been performed in the writing period 32. In other words, firstly, a positive sustain pulse is applied to the scan electrodes SCN1 to SCNn to generate a discharge. Then, a sustain pulse is applied to the scan electrodes SCN1 to SCNn and the sustain electrodes SUS1 to SUSn so that polarities thereof alternately change, in order to sustain the light emission intermittently.

### <Elimination Period 34>

In an elimination period 34, an elimination discharge is selectively generated only in a discharge cell in which a sustain operation is performed in the sustain period immediately before the elimination period, in order to perform an elimination operation of eliminating a wall charge. In the elimination period 34, an elimination voltage whose phase difference duration with the scan electrodes SCN1 to SCNn is small is applied to the sustain electrodes SUS1 to SUSn. As a result, an incomplete discharge is generated, and a part of the wall charge is eliminated to prepare for an initialization operation of the next S.F.

### (Structure of Drive Unit)

The following describes a structure of a drive unit.

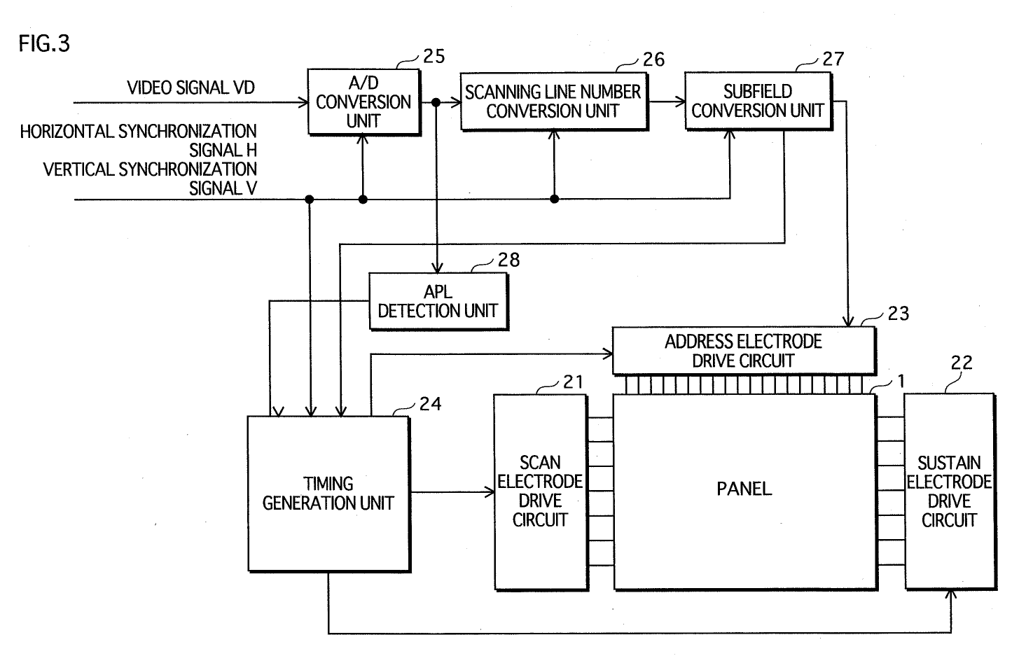

FIG. 3 is a block diagram showing the structure of the display drive unit.

This drive unit includes a scan electrode drive circuit 21, a sustain electrode drive circuit 22, an address electrode drive circuit 23, a timing generation unit 24, an A/D (Analog/Digital) conversion unit 25, a scanning line number conversion unit 26, a subfield conversion unit 27, an APL (Averaged Picture Level) detection unit 28, and the like.

In the drive unit, a video signal VD is inputted to the A/D conversion unit 25, and a horizontal synchronization signal H and a vertical synchronization signal V are inputted to the A/D conversion unit 25, the scanning line number conversion unit 26, and the subfield conversion unit 27. The vertical synchronization signal V is also inputted to the timing generation unit 24.

The A/D conversion unit 25 converts the inputted video signal VD into image data of a digital signal, and outputs the converted image data to the scanning line number conversion unit 26 and the APL detection unit 28.

The scanning line number conversion unit 26 converts the image data received from the A/D conversion unit 25 into image data corresponding to the number of pixels of the PDP 1, and outputs the converted image data to the subfield conversion unit 27. The subfield conversion unit 27 includes a subfield memory (not illustrated), and converts the image data transferred from the scanning line number conversion unit 26 into subfield data that is a set of binary data indicating lighting/non-lighting of a discharge cell in each subfield for causing the PDP 1 to perform gradation display. Then, the subfield conversion unit 27 stores the converted subfield data in the subfield memory. After that, the subfield conversion unit 27 outputs the subfield data to the scan electrode drive circuit 21 based on a timing signal from the timing generation unit 24.

The APL detection unit 28 detects an average luminance level of the image data. In the drive unit, a drive waveform is controlled based on the detected average luminance level.

The timing generation unit 24 generates a field starting signal after a certain period of time from the input of the vertical synchronization signal V. Then, the timing generation unit 24 generates a timing signal for instructing a start of an initialization period, a writing period, and a sustain period of each subfield based on this field starting signal. Also, the timing generation unit 24 counts clocks based on this timing signal to generate a timing signal for indicating a timing of pulse generation to each of the scan electrode drive circuit 21, the sustain electrode drive circuit 22, and the address electrode drive circuit 23. Then, the timing generation unit 24 outputs the various timing signals to each of the scan electrode drive circuit 21, the sustain electrode drive circuit 22, and the address electrode drive circuit 23.

Therefore, a setting time from a start of each subfield to a rising of each pulse and a setting time from a start of each subfield to a falling of each pulse are converted into the number of clocks CLK and stored in the timing generation unit 24. At the same time of the start of the subfield, the timing generation unit 24 resets a time counter CT and indicates the pulse rising or the pulse falling to each of the scan electrode drive circuit 21, the sustain electrode drive circuit 22, and the address electrode drive circuit 23 when the time counter CT reaches each setting time.

Each of the scan electrode drive circuit 21, the sustain electrode drive circuit 22, and the address electrode drive circuit 23 includes a publicly known driver IC and the like, and applies a drive pulse to the PDP 1 based on the timing signals transmitted from the timing generation unit 24 as follows.

The scan electrode drive circuit 21 applies a scan pulse having an amplitude of Vh(V) and a sustain pulse having an amplitude of Vm(V) to the scan electrodes SCN1 to SCNn based on the timing signals transmitted from the timing generation unit 24.

The sustain electrode drive circuit 22 applies a sustain pulse having an amplitude of Vm(V) to the sustain electrodes SUS1 to SUSn based on the timing signals transmitted from the timing generation unit 24.

The address electrode drive circuit 23 applies an address pulse to any of the address electrodes D1 to Dm selected based on the subfield data in a writing period, based on the timing signals transmitted from the timing generation unit 24.

Also, when a preceding subfield does not include a sustain period, the address electrode drive circuit 23 performs an priming operation by collectively applying a priming pulse to the address electrodes D1 to Dm based on the timing signals transmitted from the timing generation unit 24 prior to the ramp waveform part S1 in the initialization period, after a writing period of the subfield ends. When a preceding subfield includes a sustain period, the address electrode drive circuit 23 performs the same priming operation after the sustain period ends. It is preferable to apply the priming pulse at the beginning of the initialization period or before the initialization period. Because of this priming operation, an initialization operation can be stably performed.

The following specifically describes the priming operation in first to sixth embodiments.

### FIRST EMBODIMENT

Each of FIGS. 5 and 7 is a timing chart of a drive waveform of the first embodiment. FIG. 7 shows only the all cells initialization period 31 in the first S.F.

In the first embodiment, in the all cells initialization period 31 in the first S.F., a priming pulse (a voltage of Vpr) of the same polarity as a polarity of the initialization pulse is applied to the address electrodes D1 to Dm in a priming period prior to the ramp waveform part S1 of the all cells initialization pulse.

In this case, the sustain electrodes SUS1 to SUSn are kept at a ground potential 0(V) as mentioned above. Therefore, each of the sustain electrodes SUS1 to SUSn is a negative voltage for the address electrodes D1 to Dm. As a result, an electron is emitted to the discharge space 20 from the protection layer 18 having a larger secondary electron emission coefficient than the phosphor layer 16 and a priming discharge is generated around the sustain electrodes SUS1 to SUSn.

It is preferable that a falling point of the priming pulse is substantially same as a starting point t3 of the ramp waveform part S1 or before the starting point t3. This is because of the following reason.

If the priming pulse is applied to the address electrodes D1 to Dm when the ramp waveform part S1 of the initialization pulse is applied, an electric potential difference between the scan electrodes and the address electrodes becomes small. As a result, a wall charge cannot be fully formed by the initialization operation, and the following writing operation cannot be normally performed. On the other hand, if a falling point of the priming pulse is substantially same as the starting point t3 of the ramp waveform part S1 or before the starting point t3, the electric potential difference between the scan electrodes and the address electrodes can be kept at an electric potential difference desired for the initialization operation. Therefore, the application of the priming pulse does not prevent the wall charge from being formed by the initialization operation.

### (Effect of Priming Discharge)

If the number of charged particles in the discharge space 20 is small when the initialization operation is performed in the ramp waveform part of the all cells initialization pulse, a weak discharge is less likely to be generated and a strong discharge is likely to be generated. In the first embodiment, however, the priming discharge is generated prior to the ramp waveform part S1 as mentioned above. Therefore, the charged particles are fully supplied to the discharge space 20, and thus a weak discharge is likely to be generated when the initialization operation is performed. This can suppress the strong discharge generated between the scan electrodes and the sustain electrodes, in addition to the strong discharge generated between the scan electrodes and the address electrodes.

Because of this, a wall charge suitable for the writing operation is accumulated when the all cells initialization period 31 ends. This can suppress the selection defect of a lighting discharge cell or a non-lighting discharge cell in the writing period, and dramatically improve flicker and roughness.

Generally, in a high-definition PDP, a ratio of a surface area to a volume of a discharge cell is large. Therefore, reabsorption and elastic collision of charged particles in a wall surface become large, and the number of the charged particles in the discharge cell becomes small before the initialization period. As a result, a strong discharge is likely to be generated between the scan electrodes and the sustain electrodes when the initialization pulse is applied. Also, in a PDP having a high partial pressure of xenon, a strong discharge is likely to be generated because of a strong electric field. Therefore, especially in the high-definition PDP and the PDP having a high partial pressure of xenon, an image quality can be dramatically improved by suppressing the strong discharge as mentioned above.

Also, if a priming discharge is generated between the sustain electrodes SUS1 to SUSn and the scan electrodes SCN1 to SCNn to which the initialization pulse is applied, the priming discharge itself is likely to be a strong discharge. In the first embodiment, however, the priming discharge is generated between the sustain electrodes SUS1 to SUSn and the address electrodes D1 to Dm. Thus, the scan electrodes SCN1 to SCNn do not directly relate to the priming discharge. As a result, the priming discharge itself is less likely to be a strong discharge.

The voltage Vpr of the priming pulse may be same as the voltage Vw of the address pulse. However, it is preferable to set the voltage Vpr of the priming pulse within a range suitable for the priming discharge, independently of the voltage Vw.

In order to certainly generate the priming discharge, it is preferable that the voltage Vpr of the priming pulse is set to be equal to or larger than a threshold voltage at which a discharge starts between the sustain electrodes SUS1 to SUSn and the address electrodes D1 to Dm.

On the other hand, when the voltage Vpr of the priming pulse is set to be 0.1 Vf or larger and smaller than Vf (Vf is a threshold voltage at which a discharge starts between the scan electrodes SCN1 to SCNn and any of the sustain electrodes SUS1 to SUSn and the address electrodes D1 to Dm), a light emission caused by the priming discharge can be suppressed. As a result, a contrast ratio can be improved. Especially if the voltage Vpr of the priming pulse is set to be 0.5 Vf or larger and smaller than Vf, a light emission caused by the priming discharge can be suppressed, and a strong discharge caused by the priming operation can be suppressed.

When a maximum value of a voltage applied to the scan electrodes SCN1 to SCNn in the all cells initialization period 31 is Vmax and a minimum value of the voltage is Vmin, it is preferable that the voltage Vpr of the priming pulse is set to be in a range of Vmin to Vmax (Vmin=Vpr=Vmax).

Because Vmax=Vh and Vmin=Vbt as shown in FIG. 7, it is preferable that the voltage Vpr is set to be in a range of Vbt to Vh (Vbt=Vpr=Vh).

### (Confirmatory Experiment of Effect of Priming Pulse)

The following describes an experiment of comparing the probability of generating the strong discharge between the driving method of the first embodiment in which the priming pulse is applied and the driving method of the first conventional example in which the priming pulse is not applied.

When a PDP is driven, a slope of a voltage change of an initialization pulse is changed to judge whether or not the strong discharge is generated, using an APD and by visual observation.

A confirmatory experiment of an effect was performed for a statistical variation time Ts of a discharge starting time, by changing a material composition of a protection layer composing a panel and an electrode arrangement to change the statistical variation time Ts when a writing operation is performed.

A “slope of a voltage” is a temporal change of a voltage applied to an electrode, and is adjusted by a circuit structure combining a P-type semiconductor, MOSFET, and a volume resistance.

A discharge form in an initialization period and an elimination period was measured by the APD as follows. A generation amount of a near-infrared ray emitted by a transition of xenon between excited states is measured using a photodiode for a near-infrared ray used as a receiving unit of a light signal (hereinafter, referred to as “APD”).

Because of this measurement, it can be judged that a form of a generated discharge is a weak discharge or a strong discharge.

If a strong discharge is generated when a PDP is turned off, an emission of visible light becomes strong. Therefore, a form of a discharge (strong or weak) can be visually confirmed.

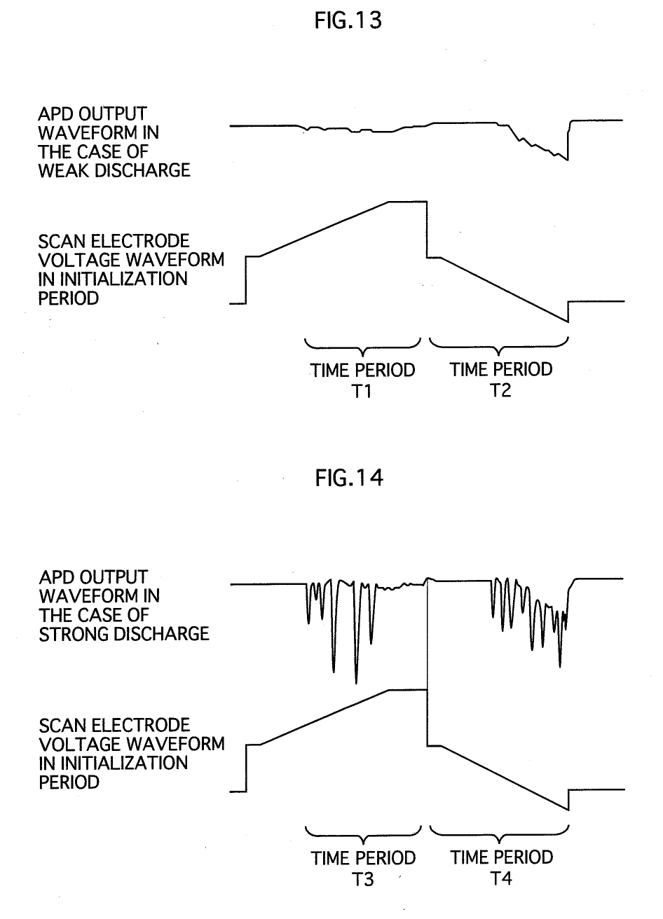

FIG. 13 shows an example of an APD output waveform when a weak discharge is normally generated in the all cells initialization period.

In FIG. 13, in a time period T1 in the all cells initialization period, an electric potential difference in the discharge space 20 is larger than an electric potential difference when a discharge starts. Also, in a time period T2, an applied voltage to the scan electrodes changes from a positive voltage to a negative voltage, and unnecessary wall charge is eliminated from the wall charge accumulated in the time period T1. However, as shown by the APD waveform in FIG. 13, it is found that ionization multiplication does not temporally drastically proceed, and a weak discharge proceeding gently is stably generated.

FIG. 14 shows an example of an APD output waveform when a strong discharge is generated in the all cells initialization period.

According to the APD output waveform shown in FIG. 14, it is found that ionization multiplication temporally drastically proceeds in a time period T3 in the all cells initialization period, and a strong discharge is generated. Also, in a time period T4, a strong discharge is generated because of an unnecessary wall charge accumulated in the time period T3, when a voltage of the scan electrode decreases from the maximum voltage or when a negative voltage is applied.

In the above-mentioned method, strong or weak of the discharge is monitored by the APD and a slope of a voltage is changed by a volume resistance to define a slope at which a strong discharge and a weak discharge switch to each other as a limit slope.

The “limit slope” is an indicator of the probability of generating the strong discharge. When the limit slope is large, the strong discharge is less likely to be generated, and when the limit slope is small, the strong discharge is likely to be generated.

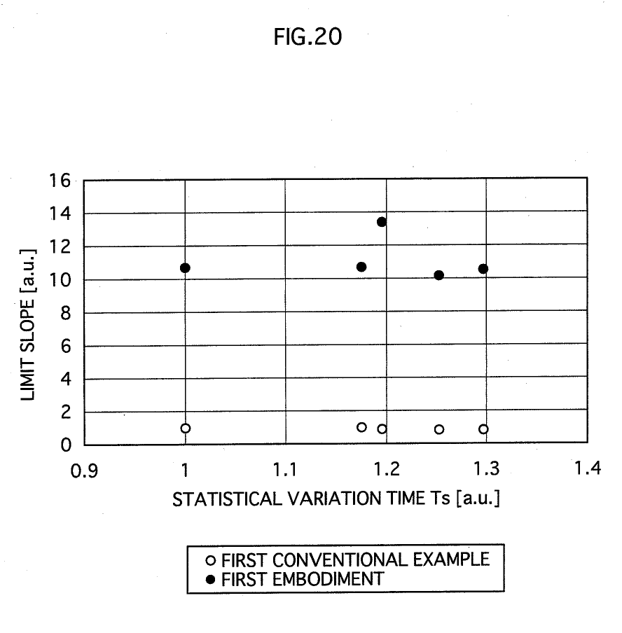

FIG. 20 shows a result of measuring each limit slope of a ramp voltage of an initialization operation in each of the driving methods of the first conventional technique and the first embodiment, and the limit slope is plotted for each statistical variation time Ts of a discharge starting time.

The result in FIG. 20 shows that when the statistical variation time Ts of a discharge starting time is large, a limit slope is small in the case of the first conventional example. On the other hand, the limit slope is large regardless of the statistical variation time Ts of a discharge starting time in the case of the first embodiment, and the limit slope of the first embodiment is 10 times larger than a limit slope of the first conventional example.

The following is the consideration from the above result.

Generally, the statistical variation time Ts relates to a probability of generating the strong discharge. If the statistical variation time Ts is large, the probability of generating the strong discharge becomes high. That is to say, the statistical variation time Ts of a discharge starting time depends on a material surrounding the discharge space 20 and an electrode arrangement. When electrons supplied to the discharge space 20 from a surface of the material surrounding the discharge space 20 is insufficient, an electron number density in the discharge space 20 becomes insufficient, and areas to which a strong electric field is applied are sparsely generated temporally and spatially. This irregularly generates drastically ionization multiplication. Therefore, the statistical variation time Ts of a discharge starting time becomes large, but the probability of generating the strong discharge becomes higher.

On the other hand, in the driving method of the first embodiment, because the priming pulse is applied before the initialization operation, the electron number density increases in the discharge space 20. As a result, the probability of generating the strong discharge can be suppressed.

### (Structure of Drive Unit Applying the Priming Pulse)

The following describes a concrete example of a circuit for generating a priming pulse having a voltage of Vpr in the priming period (from t2 to t3) in the first S.F.

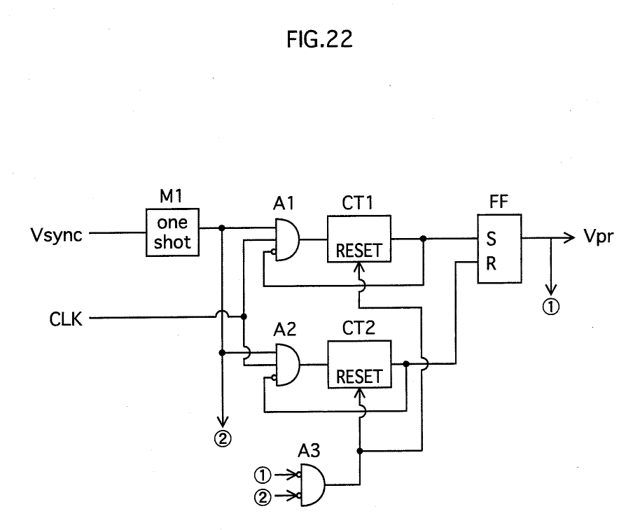

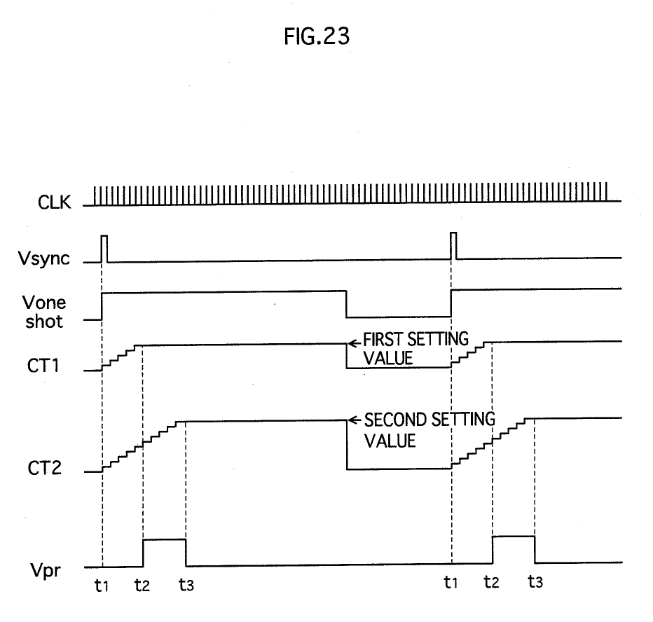

FIG. 22 shows an example of a circuit for generating a priming pulse, and FIG. 23 is a timing chart describing an operation of the circuit.

The timing generation unit 24 generates the priming pulse in the first S.F. using the circuit shown in FIG. 22.

As shown in FIG. 22, this circuit includes one-shot multi M1 that generates a pulse having a predetermined time constant, AND circuits A1, A2, and A3, counters CT1 and CT2, and a flip-flop circuit FF. A vertical synchronization signal Vsync is inputted to the one-shot multi M1. Here, it is assumed that each video field starts at the vertical synchronization signal Vsync, and a pulse of the one-shot multi M1 rises by the vertical synchronization signal Vsync. However, if a starting point of the first S.F. delays than the vertical synchronization signal Vsync, the vertical synchronization signal Vsync may be given to the one-shot multi M1 via a delay circuit corresponding to an amount of the delay. The time constant of the one-shot multi M1 may be set to be in a proper range within a time of one field, and is normally set to be in a range of a time of the first S.F.

In FIG. 23, P1 indicates a pulse generated by the one-shot multi M1, CLK indicates a clock pulse, and Vsync indicates the vertical synchronization signal.

In the circuit having the above structure, the AND circuits A1 and A2 open a gate when the one-shot multi M1 generates the pulse P1 and until the counters CT1 and CT2 count the maximum count numbers respectively, to supply the clock pulse to the counters CT1 and CT2.

The maximum count number of the counter CT1 (hereinafter, referred to as “first setting value”) is set to a count number corresponding to a time from when a gate of the AND circuit A1 opens to the time t2 at which the priming pulse rises. The maximum count number of the counter CT2 (hereinafter, referred to as “second setting value”) is set to a count number corresponding to a time from when a gate of the AND circuit A2 opens to the time t3 at which the priming pulse falls.

When the count number of the counter CT1 reaches the first setting value, an output of the counter CT1 shifts to an H level and the flip-flop FF is set. On the other hand, when the count number of the counter CT2 reaches the second setting value, an output of the counter CT2 shifts to the H level and the flip-flop FF is reset.

As a result, an output from a Q terminal of the flip-flop FF rises only from when the counter CT1 reaches the first setting value to when the counter CT2 reaches the second setting value. This forms a priming pulse (a voltage of vpr) that rises at the time t2 and falls at the time t3.

When each of the count numbers of the counters CT1 and CT2 reaches each setting value and an output of each of the counters CT1 and CT2 shifts to the H level, an input of each of the AND circuits A1 and A2 shifts to a L level. Therefore, the AND gate is closed. As a result, the clocks are not supplied to the counters CT1 and CT2, and the count number of each of the counters CT1 and CT2 is kept at the setting value. However, when the priming pulse falls and the pulse of the one-shot multi M1 falls, an output of the AND circuit A3 shifts to the H level, and is added to a reset terminal of each of the counters CT1 and CT2. As a result, the counters CT1 and CT2 are reset and the count numbers are zero.

This state is completed by the time when the next vertical synchronization signal Vsync rises. Therefore, when the next vertical synchronization signal Vsync arrives, the same operation as mentioned above is repeated, and the priming pulse is outputted from the flip-flop FF.

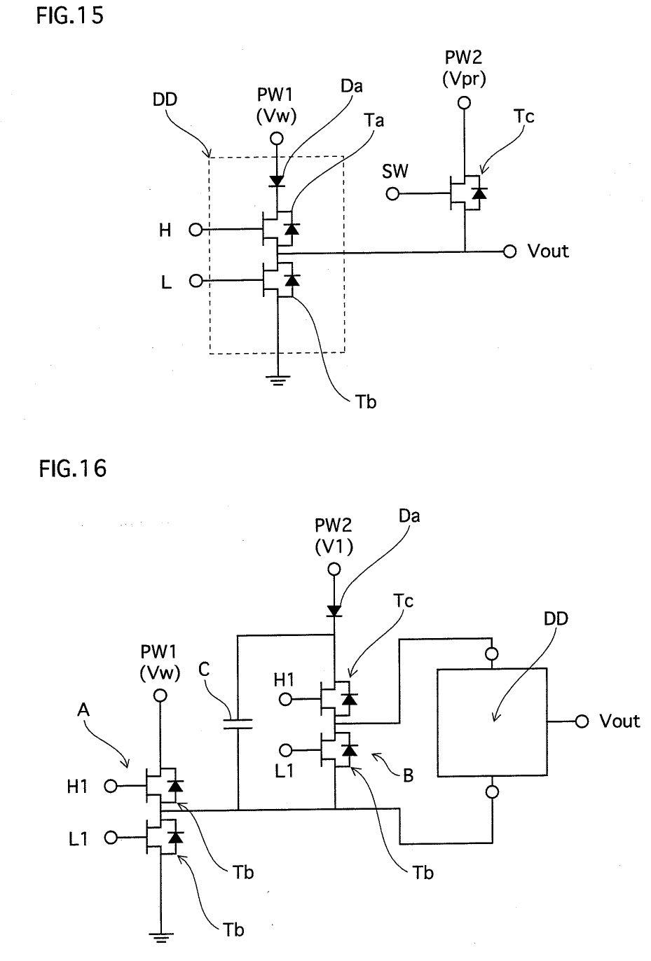

The following describes a structure of the address electrode drive circuit 23, with reference to FIGS. 15 and 16. The address electrode drive circuit 23 applies an address pulse (a voltage of Vw) to the address electrodes D1 to Dm in the writing period, and applies a priming pulse (a voltage of Vpr that is different from Vw) to the address electrodes D1 to Dm in the priming period.

Each of FIGS. 15 and 16 shows the structure of the address electrode drive circuit 23. The address electrode drive circuit 23 includes two types of power supplies PW1 (a voltage of Vw) and PW2 (a voltage of Vpr). Each of the PW1 and the PW2 controls an output in a different system so as to output the priming pulse to the address electrodes D1 to Dm at the voltage Vw and the voltage Vpr.

The circuit shown in FIG. 15 includes an address electrode drive circuit DD in which a high-side switching element Ta and a low-side switching element Tb are connected in series between a power supply terminal (Vw) and a ground 0 (V), a protection diode Db out of two protection diodes connected in parallel with the high-side switching element Ta is removed, and a protection diode Da for preventing backward flow from the power supply PW2 to the power supply PW1 is inserted between the power supply PW2 and the power supply PW1. Also, a control terminal H controls the high-side switching element Ta, and a control terminal L controls the low-side switching element Tb.

The address electrode drive circuit DD is same as an address electrode drive circuit that is conventionally used for a PDP. The subfield data is inputted to the address electrode drive circuit DD from the subfield conversion unit 27, and the address electrode drive circuit DD applies an address pulse Vw to any of the address electrodes D1 to Dm selected based on the subfield data by the power supply PW1.

In addition to the address electrode drive circuit DD, the circuit shown in FIG. 15 also includes the power supply PW2 and a switching element Tc before an output terminal Vout. The power supply PW2 outputs the voltage Vpr for performing a priming operation, and the switching element Tc controls the output by the power supply PW2.

In the address electrode drive circuit 23, when a control terminal SW turns the switching element Tc OFF in the writing period, an ON/OFF operation of the high-side switching element Ta and the low-side switching element Tb is performed in the address electrode drive circuit DD to apply an address pulse of the voltage of Vw to the address electrodes.

On the other hand, when the high-side switching element Ta and the low-side switching element Tb are OFF in the priming period, the control terminal SW turns the switching element Tc ON to apply a priming pulse of the voltage of Vpr.

FIG. 16 shows a circuit structure in which a low side of the address electrode drive circuit DD is raised from a ground potential 0 (V) to a voltage of Vw.

This circuit includes a combinational circuit A in which the high-side switching element Ta and the low-side switching element Tb are connected in series between a voltage Vpr and a ground 0(V). Also, a combinational circuit B is inserted between an output terminal of the combinational circuit A and the power supply PW1. The combinational circuit 1 includes a capacitor C for a charge pump, the switching element Tc for adjusting a timing of raising a ground potential, and the diode Da for preventing backward flow. The present invention is not limited to the capacitor C for a charge pump, and may be a circuit for stably outputting the voltage Vw, such as a DC-DC converter.

An output of the combinational circuit A is connected to the low side of the address electrode drive circuit DD, and an output of the combinational circuit B is connected to the high side of the address electrode drive circuit DD.

In the address electrode drive circuit 23, when the low-side switching element Tb of the combinational circuit A is ON in the writing period, control of applying an address pulse of the voltage Vw to the address electrodes is performed by the address electrode drive circuit DD. On the other hand, in the priming period, when the low-side switching element Tb of the combinational circuit A is OFF and the switching element Tc connected to the high side of the address electrode drive circuit DD is OFF, the high-side switching element Ta of the combinational circuit A is turned ON. After the ground potential of the low side of the address electrode drive circuit DD is stabilized, the switching element Tc is turned ON to superimpose a voltage Vpr and apply a priming pulse of a voltage of Vw+Vpr.

In the first embodiment, the sustain electrodes SUS1 to SUSn are at a ground potential 0(V), and the positive voltage Vpr is applied to the address electrodes D1 to Dm in the priming period 35 to perform the priming discharge. However, the method of applying a voltage to the address electrodes D1 to Dm and the sustain electrodes SUS1 to SUSn is not limited to this. The same effect can be obtained by a method which can form an electric potential difference for supplying charged particles to the discharge space between the address electrodes D1 to Dm and the sustain electrodes SUS1 to SUSn in the printing period 35.

Also, in the priming period 35, the sustain electrodes SUS1 to SUSn may be at a ground potential 0(V), and the address electrodes D1 to Dm may be in a floating state. As shown in FIG. 7, the positive voltage Va(V) is applied to the scan electrodes SCN1 to SCNn in the priming period 35. Therefore, the address electrodes D1 to Dm in the floating state also become a positive electric potential, and an electric potential difference is formed between the address electrodes D1 to Dm and the sustain electrodes SUS1 to SUSn. This can generate the priming discharge.

As mentioned above, if the priming discharge is generated using the method of putting the electrodes into the floating state, it is not required to apply the priming pulse. Therefore, electric power consumption can be suppressed.

### SECOND EMBODIMENT

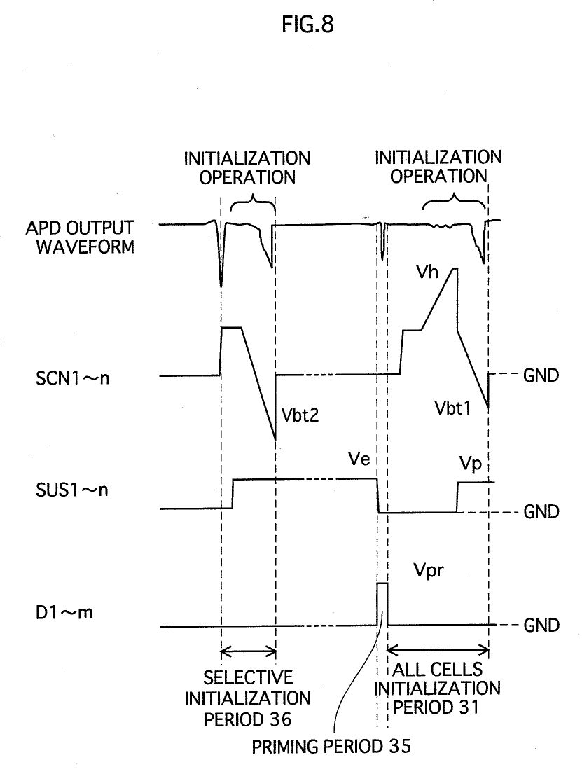

As shown in FIG. 8, in a second embodiment, the priming pulse of the positive voltage Vpr is applied to the address electrodes D1 to Dm in the priming period 35 same as in the first embodiment. However, a minimum voltage of an initialization pulse is set to be low (so that an absolute value |Vbt| of a negative voltage is large) in an arbitrary S.F. before the priming period 35 (which may be a S.F. immediately preceding to the priming period 35, a S.F. two-preceding to the priming period 35, or a S.F. three-preceding to the priming period 35).

### THIRD EMBODIMENT

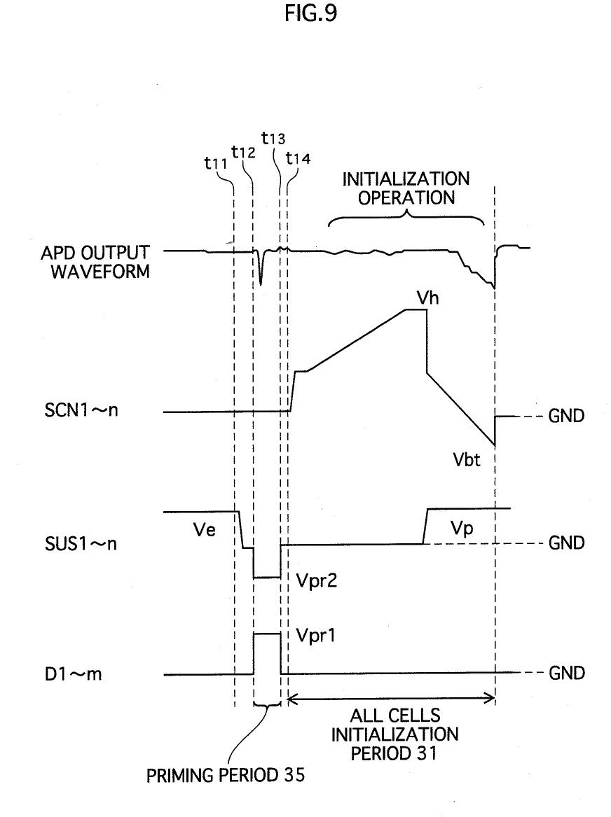

FIG. 9 is a timing chart of a drive waveform of a third embodiment, and shows only around the all cells initialization period 31.

In a driving method of the third embodiment, the priming period 35 (from t12 to t13) is provided between a time point t11 at which one TV field starts after a preceding TV field ends and a time point t14 at which the all cells initialization period of a first S.F. starts. In the priming period 35, a priming pulse of a positive voltage of Vpr1 is applied to the address electrodes D1 to Dm and a priming pulse of a negative voltage of Vpr2 is applied to the sustain electrodes SUS1 to SUSn. As a result, a voltage (Vpr1-Vpr2) is formed between the address electrodes D1 to Dm and the sustain electrodes SUS1 to SUSn to perform the priming discharge.

As shown in FIG. 9, in the priming period 35, a priming pulse of a positive voltage (Vpr1) may be applied to the address electrodes D1 to Dm and a priming pulse of a negative voltage (Vpr2) may be applied to the sustain electrodes SUS1 to SUSn.

In the third embodiment, an electric potential of each of the sustain electrodes SUS1 to SUSn is lowered from a positive electric potential Ve to a ground potential 0(V) at the time point t11 at which one TV field starts. Then, an electric potential of each of the address electrodes D1 to Dm is raised from a ground potential 0(V) to the positive electric potential Vpr1 at the time point t12 at which the priming period starts. In addition, a voltage lowering from the ground potential 0(V) to the negative electric potential Vpr2 is applied to each of the sustain electrodes SUS1 to SUSn. Then, the electric potential of each of the address electrodes D1 to Dm and each of the sustain electrodes SUS1 to SUSn is returned to the ground potential 0(V) at the time point t13 at which the priming period ends.

As a result, in the priming period 35 before the initialization pulse is applied to the scan electrodes SCN1 to SCNn, the voltage (Vpr1−Vpr2) is formed between the address electrodes D1 to Dm and the sustain electrodes SUS1 to SUSn, and the priming discharge is generated.

The effect of the driving method of the third embodiment has been described in the first embodiment. However, in the third embodiment, the voltage Pr formed between the address electrodes D1 to Dm and the sustain electrodes SUS1 to SUSn in the priming period is (Vpr1−Vpr2), and |Pr|=|Vpr1|+|Vpr2|. Therefore, a large voltage can be formed between the address electrodes D1 to Dm and the sustain electrodes SUS1 to SUSn, even if a voltage of a priming pulse applied to each of the address electrodes D1 to Dm and each of the sustain electrodes SUS1 to SUSn is small.

It is preferable to set the positive voltage Vpr1 and the negative voltage Vpr2 of the priming pulse so that the voltage (Vpr1-Vpr2) is equal to or larger than a threshold voltage at which a discharge starts between the sustain electrodes SUS1 to SUSn and the address electrodes D1 to Dm, in order to certainly generate the priming discharge.

On the other hand, when the positive voltage Vpr1 and the negative voltage Vpr2 are set so that the voltage (Vpr1-Vpr2) is 0.1 Vf or larger and smaller than Vf (note that Vf is a threshold voltage at which a discharge starts between the scan electrodes SCN1 to SCNn and any of the sustain electrodes SUS1 to SUSn and the address electrodes D1 to Dm), a light emission caused by the priming discharge can be suppressed. Thus, a contrast ratio can be improved.

### (Structure of Drive Unit for Applying the Priming Pulse)

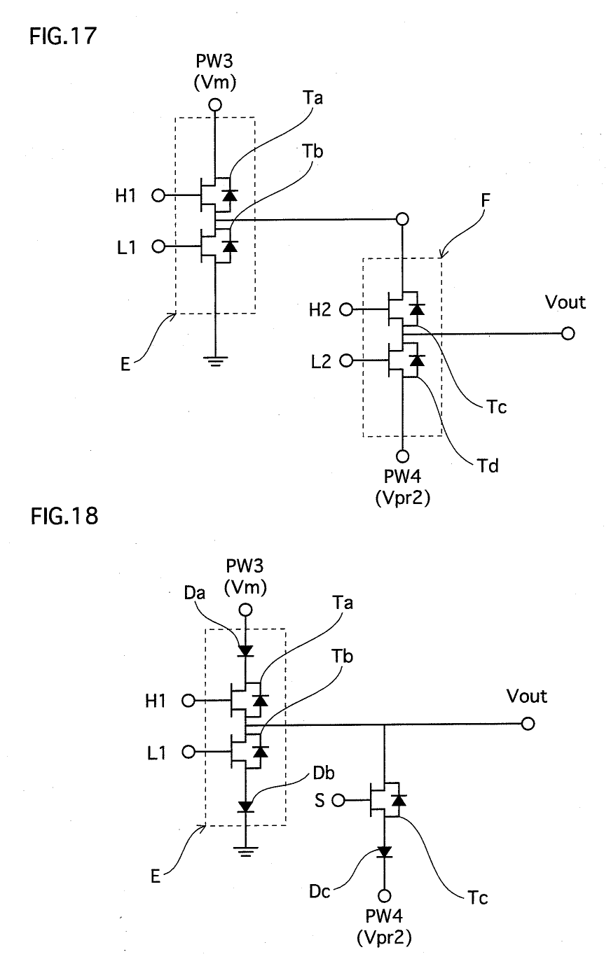

The following describes a structure of the sustain electrode drive circuit 22, with reference to FIGS. 17 to 19. The sustain electrode drive circuit 22 applies a sustain pulse of the positive voltage of Vm to the sustain electrodes SUS1 to SUSn in the sustain period, and applies a priming pulse of the negative voltage of Vpr2 to the sustain electrodes SUS1 to SUSn in the priming period.

Each of circuits shown in FIGS. 17 to 19 shows an example of the sustain electrode drive circuit 22 of the third embodiment. Each sustain electrode drive circuit includes a power supply PW3 (a positive voltage of Vm) for outputting a positive sustain pulse, and a power supply PW4 (a negative voltage of Vpr2) for outputting a negative priming pulse.

The circuit shown in FIG. 17 includes a circuit E in which a high-side switching element Ta and a low-side switching element Tb are connected in series between the power supply PW3 (Vm) and a ground terminal. Also, the circuit shown in FIG. 17 includes a circuit F in which a high-side switching element Tc and a low-side switching element Td are connected in series between an output terminal of the circuit E and the power supply PW4 (Vpr2).

In this sustain electrode drive circuit, when the high-side switching element Tc of the separation circuit F is ON and the low-side switching element Td is OFF in the sustain period, the high-side switching element Ta and the low-side switching element Tb of the circuit E are alternately ON/OFF to apply a sustain pulse of an amplitude of Vm(V).

On the other hand, when the high-side switching element Ta of the circuit E is OFF and the low-side switching element Tb is ON in the priming period 35, the high-side switching element Tc and the low-side switching element Td of the separation circuit F are controlled to output the priming pulse of a negative voltage.

Because of this operation, the positive sustain pulse is applied to the sustain electrodes SUS1 to SUSn in the sustain period, and the negative priming pulse is applied to the sustain electrodes SUS1 to SUSn in the priming period.

The circuit shown in FIG. 18 includes the circuit E for outputting a sustain pulse (a voltage of Vm). Also, the circuit shown in FIG. 18 includes the switching element Tc and a diode Dc between an output terminal Vout of the circuit E and a power supply Vpr.

In this sustain electrode drive circuit, when the switching element Tc is OFF in the sustain period, the high-side switching element Ta and the low-side switching element Tb of the circuit E are alternately ON/OFF to apply a sustain pulse of an amplitude of Vm(V).

On the other hand, when the high-side switching element Ta and the low-side switching element Tb of the circuit E are OFF in the priming period 35, the high-side switching element Tc and the low-side switching element Td of the separation circuit F are controlled to output the priming pulse of a negative voltage.

Because of this operation, the positive sustain pulse is applied to the sustain electrodes SUS1 to SUSn in the sustain period, and the negative priming pulse is applied to the sustain electrodes SUS1 to SUSn in the priming period.

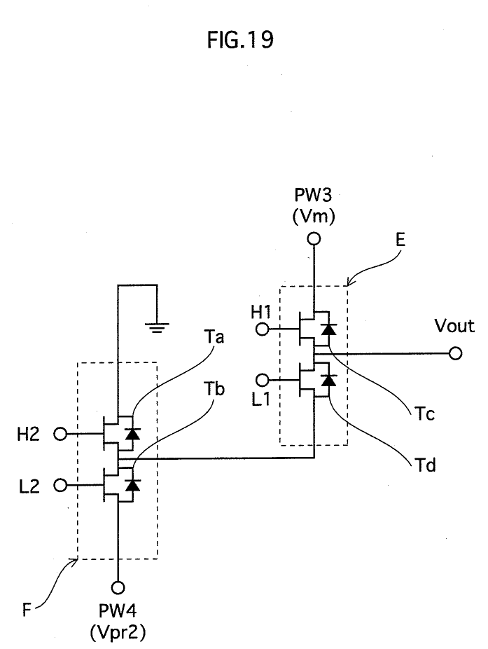

The circuit shown in FIG. 19 includes the circuit F in which the high-side switching element Ta and the low-side switching element Tb are connected in series between a ground terminal 0(V) and the power supply PW4 (a negative voltage of Vpr2). Also, the circuit shown in FIG. 19 includes the circuit E in which the high-side switching element Tc and the low-side switching element Td are connected in series between an output terminal of the circuit F and the power supply Vm.

In this sustain electrode drive circuit, when the high-side switching element Ta of the circuit F is ON and the low-side switching element Tb is OFF in the sustain period, the high-side switching element Tc and the low-side switching element Td of the circuit E are alternately turned ON to apply a sustain pulse of an amplitude of Vm(V).

On the other hand, when the high-side switching element Tc of the circuit E is OFF and the low-side switching element Td is ON in the priming period 35, the high-side switching element Tc and the low-side switching element Td of the circuit F are controlled to output the priming pulse of a negative voltage.

Because of this operation, the positive sustain pulse is applied to the sustain electrodes SUS1 to SUSn in the sustain period, and the negative priming pulse is applied to the sustain electrodes SUS1 to SUSn in the priming period.

### FOURTH EMBODIMENT

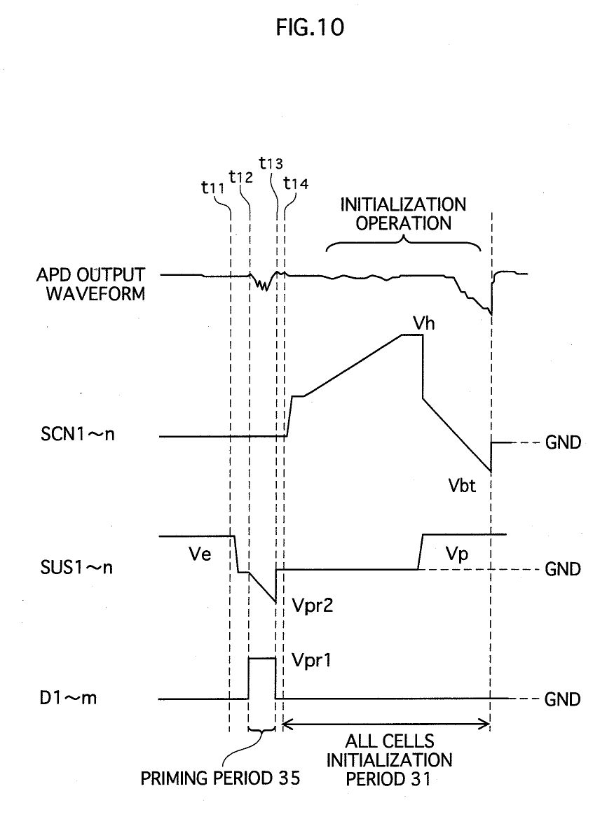

FIG. 10 is a timing chart of a drive waveform of a fourth embodiment, and is same as the third embodiment. However, a ramp voltage which gently declines from a ground potential 0V is applied to the sustain electrodes SUS1 to SUSn in the priming period 35.

Although it is not illustrated, a ramp circuit may be connected to a control terminal L2 in the circuit F in FIG. 17 so that an output declines to the negative voltage of Vpr2 in a ramp waveform, in order to apply a ramp voltage in the priming period 35.

In the fourth embodiment, the following effect can be obtained in addition to the effect of the third embodiment. Because a pulse applied to the sustain electrodes SUS1 to SUSn in the priming period is in a ramp waveform (the address electrodes D1 to Dm are kept at the positive voltage of Vpr1 and the sustain electrodes SUS1 to SUSn gently decline from the ground potential 0V to the negative electric potential Vpr2), a light emission caused by the priming discharge can be suppressed and a contrast ratio can be improved.

Also, in addition to providing the ramp waveform part when the priming pulse starts, a ramp waveform part which gently returns when the priming pulse ends can be provided in order to control a false discharge caused by a rapid voltage change after the priming discharge.

### FIFTH EMBODIMENT

In a fifth embodiment, in each S.F. after a first S.F., a priming operation is performed by applying a priming pulse of a positive voltage of Vpr to the address electrodes D1 to Dm prior to a ramp waveform part of a selective initialization pulse in the S.F., after a writing period of the preceding S.F. ends.

FIG. 11 is a timing chart of a drive waveform of the fifth embodiment, and shows from a first S.F. to the middle of a second S.F. in one TV field. In the fifth embodiment shown in FIG. 11, a selective initialization pulse having a ramp waveform part S3 (from t24 to t25) which gently declines from a voltage Vq(V) to a voltage Vbt (V) is applied to the scan electrodes SCN1 to SCNn in the selective initialization period 36 of the second S.F. As a result, the sustain electrodes SUS1 to SUSn are kept at a voltage Vh(V), and the address electrodes D1 to Dm are kept at a ground potential 0(V).

Because of the selective initialization pulse, a slight initialization discharge is selectively generated in a discharge cell in which a sustain discharge has been performed in the first S.F., and the initialization discharge is adjusted to a wall charge suitable for a writing operation.

Moreover, the priming period 35 is provided between a time point t21 at which the second S.F. following the elimination period 34 of the first S.F. starts and a time point t24 at which the ramp waveform part S3 of the selective initialization period 36 starts. In the priming period 35, a priming pulse of a positive voltage of Vpr is applied to the address electrodes D1 to Dm, and electric potentials of the sustain electrodes SUS1 to SUSn are decreased from the positive voltage Vr to 0V. As a result, a voltage of the address electrodes D1 to Dm is Vpr for the sustain electrodes SUS1 to SUSn in the priming period 35, and a priming discharge is generated.

Note that the drive unit described in the first embodiment can be used as a drive unit for applying a priming pulse in the fifth embodiment.

### (Effect of the Driving Method of the Fifth Embodiment)

The fifth embodiment can basically obtain the same effect as in the case of the all cells initialization described in the first embodiment.

That is to say, if the priming discharge is generated prior to the ramp waveform part in the selective initialization period 36, charged particles are fully supplied to the discharge space 20 same as in the first embodiment. As a result, a weak discharge is likely to be generated when an initialization operation is performed. This can suppress the strong discharge generated between the scan electrodes and the sustain electrodes, in addition to the strong discharge generated between the scan electrodes and the address electrodes.

Because of this, a wall charge suitable for a writing operation of each discharge cell is accumulated when the selective initialization period 36 ends. This can suppress the selection defect of a lighting cell or a non-lighting cell in the writing period, and dramatically improve flicker and roughness of an image. A great effect can be obtained by suppressing the strong discharge especially in a high-definition PDP.

Because the priming discharge is generated between the address electrodes D1 to Dm and the sustain electrodes SUS1 to SUSn in the fifth embodiment, the scan electrodes SCN1 to SCNn are not directly involved in the priming discharge. Therefore, the priming discharge itself is less likely to be the strong discharge.

In the fifth embodiment, it is preferable to set the voltage Vpr of the priming pulse to be equal to or larger than a threshold voltage at which a discharge starts between the sustain electrodes SUS1 to SUSn and the address electrodes D1 to Dm, in order to certainly generate the priming discharge.

On the other hand, if the voltage Vpr of the priming pulse is set to be 0.1 Vf or larger and smaller than Vf (note that Vf is a threshold voltage at which a discharge starts between the scan electrodes SCN1 to SCNn and any of the sustain electrodes SUS1 to SUSn and the address electrodes D1 to Dm), a light emission caused by the priming discharge can be suppressed. Thus, a contrast ratio can be improved.

When a maximum value of a voltage applied to the scan electrodes SCN1 to SCNn in the selective initialization period 36 is Vmax, and a minimum value of the voltage is Vmin (=Vbt), it is preferable that the voltage Vpr of the priming pulse is set to be in a range of Vmin to Vmax (Vmin=Vpr=Vmax).

Note that in the fifth embodiment, in the priming period 35, the address electrodes D1 to Dm may be in a floating state, as described in the first embodiment. A positive voltage Vq (V) is applied to the scan electrodes SCN1 to SCNn in the priming period 35. Therefore, the address electrode D1 to Dm in the floating state also become a positive electric potential, and an electric potential difference is formed between the address electrodes D1 to Dm and the sustain electrodes SUS1 to SUSn. This can generate a priming discharge.

Although the second S.F. has been described here, the same effect of suppressing the strong discharge can be obtained in any S.F. after the first S.F. by applying the priming pulse prior to the ramp waveform part S3 of the selective initialization pulse.

In the chart shown in FIG. 11, the priming pulse is not applied to the address electrodes D1 to Dm in the first S.F. However, it is preferable to suppress the generation of the strong discharge in the all cells initialization period 31 by applying the priming pulse in the first S.F., as described in the first to fourth embodiments.

### SIXTH EMBODIMENT

In the fifth embodiment, the priming period 35 is provided after the elimination period 34 of the immediately preceding S.F. ends. However, the priming pulse may be applied during the elimination operation of eliminating an electric charge formed in the discharge space 20 in the immediately preceding S.F., or before the elimination operation.

FIG. 12 is a timing chart of a waveform of a sixth embodiment.

In the sixth embodiment, the second S.F. includes the elimination period 34 in which an electric charge is eliminated in a ramp waveform, prior to a ramp waveform part which gently declines from a voltage Vq(V) to a voltage Vbt(V) in the selective initialization period 36. Also, the priming period 35 is provided immediately before the elimination period 34. In the priming period 35, a priming pulse of a positive voltage of Vpr is applied to the address electrodes D1 to Dm. As a result, a voltage of the address electrodes D1 to Dm is Vpr for the sustain electrodes SUS1 to SUSn, and a priming discharge is generated.

Because of this, the same effect described in the fifth embodiment can be obtained.

### [Modifications]

As described in the first to sixth embodiments, it is preferable to generate the priming discharge between the sustain electrodes SUS1 to SUSn and the address electrodes D1 to Dm, other than in the scan electrodes SCN1 to SCNn. However, it is not limited to between the sustain electrodes SUS1 to SUSn and the address electrodes D1 to Dm. In addition to generating the priming discharge mainly between the sustain electrodes SUS1 to SUSn and the address electrodes D1 to Dm, the priming discharge may be generated between the scan electrodes SCN1 to SCNn and the address electrodes D1 to Dm, and between the scan electrodes SCN1 to SCNn and the sustain electrodes SUS1 to SUSn.

As mentioned above, even if the electrodes involved in the discharge are different, the same effect can be obtained by forming an electric potential difference for supplying charged particles to the discharge space to generate the priming discharge.

Also, the method of applying a voltage to the address electrodes D1 to Dm and the sustain electrodes SUS1 to SUSn is not limited to the method described in the above embodiments. The same effect can be obtained if an electric potential difference for supplying charged particles to the discharge space can be formed between the address electrodes D1 to Dm and the sustain electrodes SUS1 to SUSn in the priming period 35.

Up to now, the method of driving the surface discharge type PDP has been described. However, the driving method of the present invention is not limited to the surface discharge type PDP, and may be applied to an opposed discharge type PDP in which opposite electrodes are formed between barrier ribs, and the same effect can be expected.

### INDUSTRIAL APPLICABILITY

The present invention is useful for an image display device such as a television because the generation of the strong discharge in the initialization operation can be suppressed and an image with a good image quality can be displayed by the priming operation before the initialization operation, in the driving method of a PDP and the drive device. When the present invention is applied especially to a high-definition PDP or a PDP in which a partial pressure ratio of xenon is high, a great effect can be obtained. Therefore, the present invention is suitable for a high-definition PDP with a full specification and a PDP having a high luminance efficiency.

1.-4. (canceled)

5. A method of driving a plasma display panel to display an image,
the plasma display panel including a first substrate having one or more first electrodes, a second substrate having one or more second electrodes, the first and second substrates being arranged in opposition to each other so that the first electrodes cross over the second electrodes, and a discharge gas enclosed between the first electrodes and the second electrodes, and
in the method, one TV field being composed of a plurality of subfields each including, out of an initialization period, a writing period, and a sustain period, one of combinations (a) the initialization period and the writing period, (b) the initialization period and the sustain period, and (c) the initialization period, the writing period, and the sustain period, wherein
in at least one of the plurality of subfields,
an initialization pulse is applied to the first electrodes in the initialization period, the initialization pulse having a sloping part that changes at a voltage change rate in a range of 0.1 V/μsec to 10 V/μsec, and
the second electrodes are put into a floating state prior to the sloping part of the initialization pulse (i) after the writing period when a subfield immediately preceding to the initialization period includes the combination (a), and (ii) after the sustain period when the immediately preceding subfield includes the combination (b) or the combination (c).

6. The driving method of claim 5, wherein
when a voltage of a same polarity as a polarity of the initialization pulse is applied to the first electrodes, the second electrodes are put into the floating state.

7.-14. (canceled)
